(19) United States
(12) Patent Application Publication
(10) Pub. No.: US 2002/0148773 A1
(43) Pub. Date: Oct. 17, 2002

(54) Cylindrical filter

(76) Inventor: Christian Mellwig, Herzebrock-Clarholz (DE)

Correspondence Address: FAY, SHARPE, FAGAN,, MINNICH & McKEE, LLP, 1100 Superior Avenue, Seventh Floor, Cleveland, OH, 44114-2518, US

(21) Appl. No.: 09/836,013

(22) Filed: Apr. 17, 2001

(51) Int. Cl. B01D 27/06

(52) U.S. Cl. 210/485; 210/493.1

(57) ABSTRACT

A cylindrical filter has a filter element with a filter surface pleated in a star shape from a filter cloth and provided with an external support element. The support element is designed as a lattice-like support cylinder with intersecting lattice bars running slantwise to the outer peaks of the star-shaped pleated filter element. The lattice bars run at an angle of 45°, or at an angle in the range of 45°, to the peaks of the star-shaped filter element. The ratio of the width of each lattice bar to the thickness is about 5:1. The distance between two lattice bars running in the same direction amounts to about 20 to 22 times the width of one lattice bar. At least a portion of the peaks of the filter element is joined to, or preferably is welded to, the lattice bars.

The invention pertains to a cylindrical filter whose filter element, having the filter surface, is pleated in a star shape from a filter cloth and is provided with an external support element. In the case of the filter element of the filter under discussion here, its-outer and inner peaks will describe a circular ring. The filter material is pleated accordingly in a zig-zag form or even in a meander-form. It is used for the most varied filtration processes. Because the product builds up on the outside, it is necessary to clean the filter from time to time. This is done by means of a gas, preferably by nitrogen, which is directed by means of a nozzle system in bursts from the inside into the filter. Due to these pressure bursts, the filter element is moved in a pulsating manner, so that after a certain time, the filter material necessarily will break. Therefore, it has long been common practice to supply a support element on the outside which consists of a wire which is coiled externally about the filter element in a spiral. This wire does not offer long-term support, since it will expand and work itself into the filter element. After a certain operating time, the wire will thus loosen and slip back and forth upon the filter element, so that the supportive effect will cease.

The present invention is based on the problem of designing a cylindrical filter of the kind described above, so that a permanent supporting element will be created in a simple manner and with a configuration which will not adversely impact the cleaning process itself.

The problem described herein is solved in that the support element is designed as a lattice-like support cylinder with intersecting lattice bars running slantwise to the outer peaks of the star-shaped pleated filter element. The support cylinder is an inherently form-stable component that does not change its shape even after a relatively long filter operating time, so that the danger of damage to the filter element is effectively prevented. Because of the lattice configuration, sufficient numbers of large openings are created to enable cleaning of the filter. In addition, because the lattice bars also run slantwise to the outer peaks of the star-shaped, pleated filter element, the peaks of the filter element will also be cleaned since the major part of these peaks is unobstructed.

In one preferred design, the lattice bars run at an angle of 45° or at an angle in the vicinity of 45°, to the peaks of the star-shaped filter element. Thus, we have one design advantage that when additionally washing the filter by use of a ring-shaped washing nozzle, the filter or the lattice-like support element will not get stuck in the washing nozzle. Thus it will be easily possible that during washing, the filter can be moved back and forth within the exceptionally tight-fitting washing nozzle and the filter can be sprayed with water under high pressure. During this spraying, the filter element will be put into an oscillating motion, but no damage to the outer peaks of the filter cloth will occur, since there is no contact with the washing nozzle. The support cylinder is formed preferably as a piece of sheet metal, and the lattice bars are formed by cutting out the openings. Preferably, the width of the lattice bars to their thickness is in a ratio of about 5:1. Thus, a large support area of the part of the filter element contacting the lattice bars will be obtained, so that no nicks or kinks will occur. The width of the lattice bars could be 5 mm, for example, so that the thickness will be in a range of one millimeter. In order that the openings or the perforations of the supporting cylinder will be large enough, in this design the lengths of the lattice bar side edges are about 20 to 22 times as great as the widths. Thus, when using the dimensions specified above for the lattice bars, we would have an opening greater than 100 times 100 mm.

To stabilize the star-shaped filter element, in this design at least a portion of the filter element peaks is joined to, or preferably, is welded to, the lattice bars. In this regard it is sufficient, for example, for every fourth peak to be joined with the associated lattice bar. Thus, when washing with water, the oscillating motion will not be prevented, of course, but it will be cushioned. To wash the filter, it will be inserted into a ring nozzle. Now in order to prevent damage to the star peak in this case, in an additional design of the invention, the filter has a conical insertion ring at one end face, whose smaller diameter is on the side facing away from the filter element. This conical insertion ring is located at the side opposite to the connection piece and is oriented forward during insertion into the ring nozzle. For precise centering, the invention provides that the greatest diameter of the insertion ring is just slightly larger than the outer diameter defined by the peaks of the filter element. Thus, the peaks will be prevented from making contact with the inner surface within the ring nozzle. The conical insertion ring 7 [sic; 13] is preferably joined by means of several angular holders to the end face of the filter.

The invention will be explained in greater detail based on the attached figures. We have:

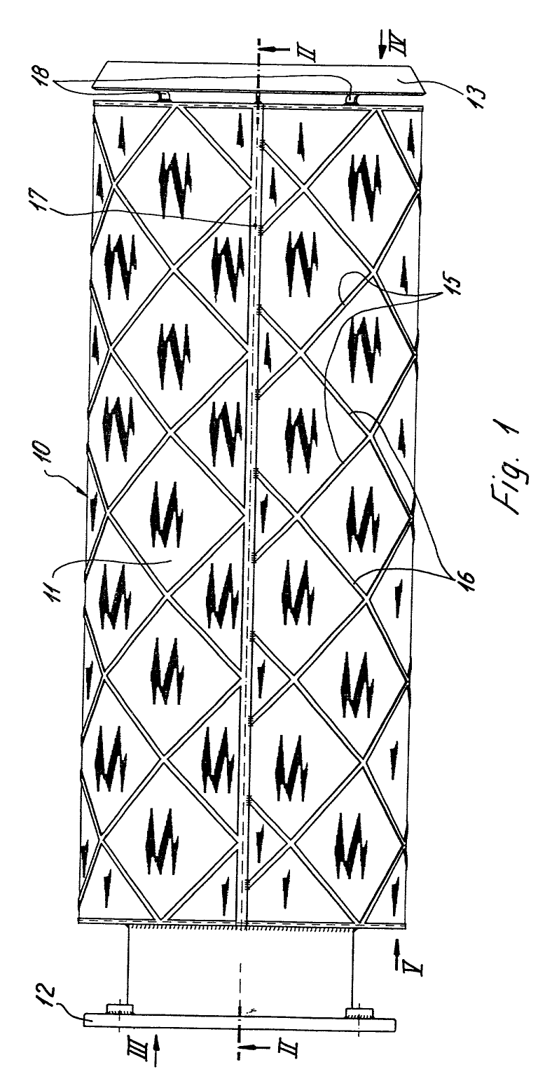

FIG. 1, a side view of a filter according to this invention,

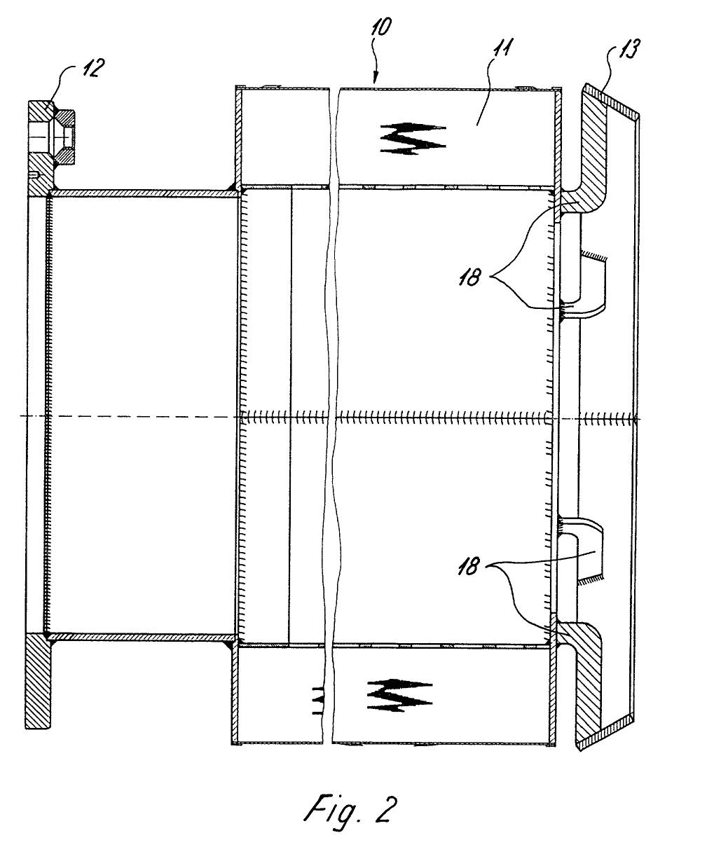

FIG. 2, a cross section along the line II-II in FIG. 1,

FIG. 3, a view in the direction of arrow III in FIG. 1,

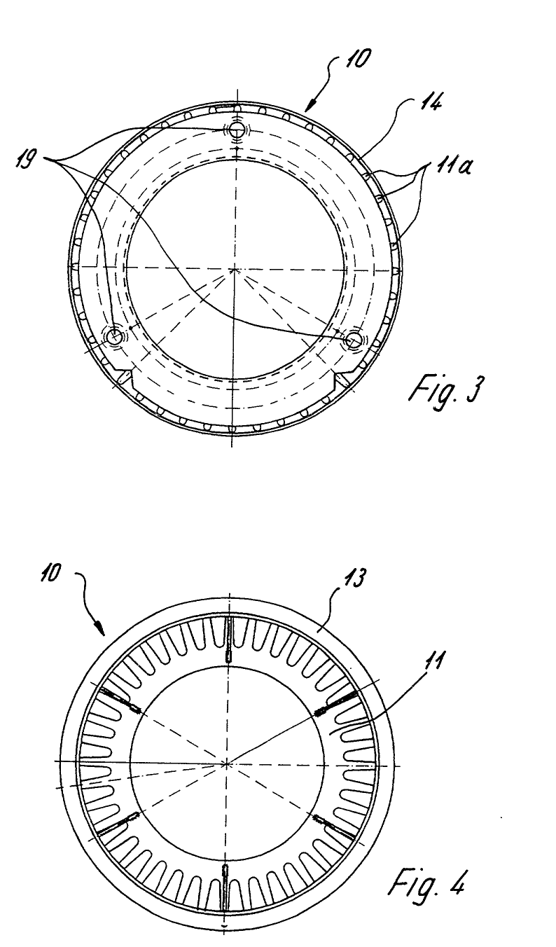

FIG. 4, a view in the direction of arrow VI [sic; IV] in FIG. 1,

FIG. 5, a view in the direction of arrow V in FIG. 1, and

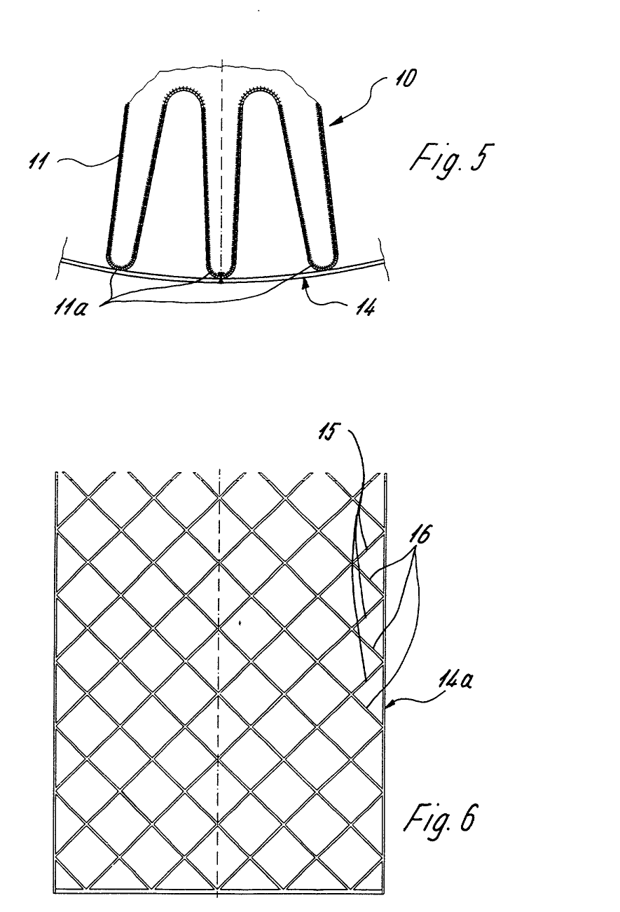

FIG. 6, the support cylinder unwound.

The filter 10 illustrated in FIG. 1 consists of a star-shaped filter element 11, illustrated in part in FIG. 5, of a connecting part 12 attached to one end face, of a conically designed insertion ring 13 mounted to the opposing end face, and of a support element surrounding the filter element 11 in the form of a support cylinder 14. The filter element 11 is produced from a metal filter cloth by zig-zag or meander-like pleating and describes a ring according to FIG. 5. The peaks 11a of the filter element 11 rest at certain locations against the inner surface of the support cylinder 14. According to FIG. 16 [sic; 6], the support cylinder 14 is produced from a planar, rectangular lattice structure 14a. This lattice structure 14a was produced from a sheet metal plate by cutting out square spaces from the sheet metal plate. We thus produce intersecting lattice bars 15 and 16, which run at an angle of 45° to the side edges of the lattice structure. A comparison of FIG. 1 with FIG. 6 shows that due to curvature, the square spaces will become rhombic spaces, but the lattice bars 15, 16 also run at an angle of about 45° to the peaks 11a of the filter element 11. The original longitudinal edges of the lattice structure 14a are joined together by a longitudinal rod 17, according to the representation of FIG. 1. In a manner not illustrated in detail, the peaks 11a produced by the pleating and extending the entire length of the filter element 11, are partly welded to the lattice bars 15. FIG. 1 shows that the greatest diameter of the insertion ring 13 is just slightly larger than the outer diameter formed by the peaks 11a of the filter element 11. In addition, the insertion ring 13 is located at a distance from the associated end surface of the filter 10. The connection is effected by means of several angular holders 18. In addition, FIG. 1 also shows that due to the formation of a cylinder from the square openings or perforations in the lattice structure 14, rhombic openings or perforations are created. Again, FIG. 2 clearly shows that the greatest diameter of the insertion ring 13 is just slightly larger than the outer diameter of the filter 10. FIG. 3 shows that the connecting part 12 is equipped with three connection holes 19, which are offset relative to each other by an angle of 120°. Whereas in FIG. 3 the outer peaks 11a of the pleated filter element 11 are seen, in FIG. 4 the inner ends are visible.

The invention is not restricted to the illustrated design example. It is essential that the support element be shape-stable and that the openings as a whole provide a far greater surface area than the total surface area of the lattice bars 15, 16. Furthermore, it is important that the lattice bars 15, 16 run slantwise to the peaks 11a of the filter element 11.

1. Cylindrical filter whose filter element, having the filter surface, is pleated in a star shape from a filter cloth and is provided with an external support element, characterized in that the support element is designed as a lattice-like support cylinder (14) with intersecting lattice bars (15, 16) running slantwise to the outer peaks (11a) of the star-shaped pleated filter element (11).

2. Cylindrical filter according to claim 1, characterized in that the lattice bars (15, 16) run at an angle of 45°, or at an angle in the range of 45°, to the peaks (11a) of the star-shaped filter element (11).

3. Cylindrical filter according to claim 1 or 2, characterized in that the ratio of the width of each lattice bar (15, 16) to the thickness is about 5:1.

4. Cylindrical filter according to one or more of the preceding claims 1 to 3, characterized in that the distance between two lattice bars (15, 16) running in the same direction amounts to about 20 to 22 times the width of one lattice bar (15, 16).

5. Cylindrical filter according to one or more of the preceding claims 1 to 4, characterized in that at least a portion of the peaks (11a) of the filter element (11) is joined to, or preferably is welded to, the lattice bars (15, 16).

6. Cylindrical filter according to one or more of the preceding claims 1 to 5, characterized in that the filter (10) has a conical insertion ring (13) at one end face, whose smaller diameter is on the side facing away from the filter element (11).

7. Cylindrical filter according to claim 6, characterized in that the greatest diameter of the insertion ring (13) is slightly larger than the outer diameter defined by the peaks (11a) of the filter element (11).

8. Cylindrical filter according to one or more of the preceding claims 1 to 7, characterized in that the support cylinder (14) is formed in a flat and rectangular lattice structure (14a).
